(19) United States
(12) Patent Application Publication
(10) Pub. No.: US 2024/0295235 A1
(43) Pub. Date: Sep. 5, 2024

(54) APPARATUS FOR FRANGIBLY SUPPORTING AN OBJECT TO A BASE

(71) Applicant: Michael Edward Cummings, Trinity, FL (US)

(72) Inventor: Michael Edward Cummings, Trinity, FL (US)

(21) Appl. No.: 18/663,122

(22) Filed: May 14, 2024

Related U.S. Application Data
(60) Provisional application No. 63/403,339, filed on Sep. 2, 2022.

(30) Foreign Application Priority Data
Sep. 1, 2023 (WO) PCT/US23/31800

(51) Int. Cl. F16B 31/02

(52) U.S. Cl. CPC F16B 31/021

(57) ABSTRACT

An apparatus for frangibly supporting an object to a base includes a lower part comprising a base coupling portion and a lower engagement portion and an upper part comprising an object coupling portion and an upper engagement portion. The base coupling portion is coupled to the base for attaching the lower part to the base. The object coupling portion is coupled to the object for attaching the object to the upper part. The upper engagement portion is disengageably engaged with the lower engagement portion for decouplably coupling the upper part with the lower part. The engaging and the disengaging of the upper engagement portion with the lower engagement portion is based on an engaging action and a disengaging action applied to the upper part in relation to the lower part.

### CROSS-REFERENCE TO RELATED APPLICATION

This application claims the benefit of international application No. PCT/US23/31800 filed on 1 Sep. 2023 and titled “AN APPARATUS FOR FRANGIBLY SUPPORTING AN OBJECT TO A BASE” which in turn claims the benefit of U.S. Provisional Patent Application No. 63/403,339, titled “REUSABLE BREAKAWAY COUPLING”, filed Sep. 2, 2022, which is incorporated by reference herein in its entirety.

### FIELD OF THE INVENTION

Generally, the present disclosure relates to the field of joints and connections. More specifically, the present disclosure relates to an apparatus for frangibly supporting an object to a base.

### BACKGROUND OF THE INVENTION

At airports, heliports, helipads, vertiports, and space launch facilities, frangible connections are used to support objects located in Airfield Frangibility Zones including but not limited to airfield safety areas, object-free areas, and other aircraft operations and aircraft parking areas. Further, a frangible connection is used to support light and other fixtures near the edges of runways, taxiways, heliports, helipads, takeoff and landing zones, and other paved and unpaved surfaces within the airfield safety areas and object-free areas designed to break away when impacted. The FAA requires lighting and sign supports to utilize a frangible connection per FAA AC-150-5220-23 of which the Advisory Circular (AC) contains standards and guidelines for the frangible connections used to support objects located in airfield safety areas and object-free areas. Current airfield light couplings fail on impact and cannot be reused or reset. Further, current couplings are typically made from materials (i.e., aluminum) that once impacted break and must be replaced.

Therefore, there is a need for improved apparatus for frangibly supporting an object to a base that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for frangibly supporting an object to a base, in accordance with some embodiments. Accordingly, the apparatus may include a lower part and an upper part. Further, the lower part may include a base coupling portion and a lower engagement portion. Further, the base coupling portion may be configured to be coupled to the base for attaching the lower part to the base. Further, the upper part may include an object coupling portion and an upper engagement portion. Further, the object coupling portion may be configured to be coupled to the object for attaching the object to the upper part. Further, the upper engagement portion may be configured to be disengageably engaged with the lower engagement portion for decouplably coupling the upper part with the lower part. Further, a shape of at least a portion of the upper engagement portion complements a shape of at least a portion of the lower engagement portion. Further, the engaging of the upper engagement portion with the lower engagement portion may be based on at least one engaging action applied to the upper part in relation to the lower part for the coupling of the upper part with the lower part. Further, the disengaging of the upper engagement portion from the lower engagement portion may be based on at least one disengaging action applied to the upper part in relation to the lower part for decoupling the upper part from the lower part. Further, the upper engagement portion may be configured for transitioning from a disengaged state to an engaged state based on the applying of the at least one engaging action for the engaging. Further, the upper engagement portion may be configured for transitioning from the engaged state to the disengaged state based on the applying of the at least one disengaging action for the disengaging.

Further disclosed herein is an apparatus for frangibly supporting an object to a base, in accordance with some embodiments. Accordingly, the apparatus may include a lower part and an upper part. Further, the lower part may include a base coupling portion and a lower engagement portion. Further, the base coupling portion may be configured to be coupled to the base for attaching the lower part to the base. Further, the upper part may include an object coupling portion and an upper engagement portion. Further, the object coupling portion may be configured to be coupled to the object for attaching the object to the upper part. Further, the upper engagement portion may be configured to be disengageably engaged with the lower engagement portion for decouplably coupling the upper part with the lower part. Further, a shape of at least a portion of the upper engagement portion complements a shape of at least a portion of the lower engagement portion. Further, the engaging of the upper engagement portion with the lower engagement portion may be based on at least one engaging action applied to the upper part in relation to the lower part for the coupling of the upper part with the lower part. Further, the disengaging of the upper engagement portion from the lower engagement portion may be based on at least one disengaging action applied to the upper part in relation to the lower part for decoupling the upper part from the lower part. Further, the upper engagement portion may be configured for transitioning from a disengaged state to an engaged state based on the applying of the at least one engaging action for the engaging. Further, the upper engagement portion may be configured for transitioning from the engaged state to the disengaged state based on the applying of the at least one disengaging action for the disengaging. Further, the upper part may include a skirting disposed on an outer surface of the object coupling portion around the object coupling portion. Further, the skirting extends away from the outer surface, wherein the skirting covers at least a portion of the upper engagement portion and the lower engagement portion for protecting at least the portion of the upper engagement portion and the lower engagement portion from at least one external element.

Further disclosed herein is an apparatus for frangibly supporting an object to a base, in accordance with some embodiments. Accordingly, the apparatus may include a lower part and an upper part. Further, the lower part may include a base coupling portion and a lower engagement portion. Further, the base coupling portion may be configured to be coupled to the base for attaching the lower part to the base. Further, the upper part may include an object coupling portion and an upper engagement portion. Further, the object coupling portion may be configured to be coupled to the object for attaching the object to the upper part. Further, the upper engagement portion may be configured to be disengageably engaged with the lower engagement portion for decouplably coupling the upper part with the lower part. Further, a shape of at least a portion of the upper engagement portion complements a shape of at least a portion of the lower engagement portion. Further, the engaging of the upper engagement portion with the lower engagement portion may be based on at least one engaging action applied to the upper part in relation to the lower part for the coupling of the upper part with the lower part. Further, the disengaging of the upper engagement portion from the lower engagement portion may be based on at least one disengaging action applied to the upper part in relation to the lower part for decoupling the upper part from the lower part. Further, the upper engagement portion may be configured for transitioning from a disengaged state to an engaged state based on the applying of the at least one engaging action for the engaging. Further, the upper engagement portion may be configured for transitioning from the engaged state to the disengaged state based on the applying of the at least one disengaging action for the disengaging. Further, the upper engagement portion may include at least one of at least one first protrusion and at least one first recess arranged in at least one first configuration. Further, the lower engagement portion may include at least one second recess and at least one second protrusion arranged in at least one second configuration. Further, at least one of the at least one first protrusion and the at least one first recess in the at least one first configuration complements at least one of the at least one second recess and the at least one second protrusion in the at least one second configuration. Further, the at least one first protrusion disengageably engages with the at least one second recess and the at least one second protrusion disengageably engages with the at least one first recess for the disengageably engaging the upper engagement portion with the lower engagement portion. Further, the upper part may include a skirting disposed on an outer surface of the object coupling portion around the object coupling portion. Further, the skirting extends away from the outer surface, wherein the skirting covers at least a portion of the upper engagement portion and the lower engagement portion for protecting at least the portion of the upper engagement portion and the lower engagement portion from at least one external element.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top perspective view of an apparatus 100 for frangibly supporting an object to a base, in accordance with some embodiments.

FIG. 2 is a front view of the apparatus 100, in accordance with some embodiments.

FIG. 3 is a top view of the apparatus 100, in accordance with some embodiments.

FIG. 4 is a bottom view of the apparatus 100, in accordance with some embodiments.

FIG. 5 is a bottom perspective view of the apparatus 100, in accordance with some embodiments.

FIG. 6 is an exploded top perspective view of the apparatus 100, in accordance with some embodiments.

FIG. 7 is an exploded front perspective view of the apparatus 100, in accordance with some embodiments.

FIG. 8 is an exploded bottom perspective view of the apparatus 100, in accordance with some embodiments.

FIG. 9 is a top perspective view of an apparatus 900 for frangibly supporting an object to a base, in accordance with some embodiments.

FIG. 10 is a front view of the apparatus 900, in accordance with some embodiments.

FIG. 11 is a bottom perspective view of the apparatus 900, in accordance with some embodiments.

FIG. 12 is a left side top perspective view of the apparatus 900, in accordance with some embodiments.

FIG. 13 is a top view of the apparatus 900, in accordance with some embodiments.

FIG. 14 is a bottom view of the apparatus 900, in accordance with some embodiments.

FIG. 15 is an exploded top perspective view of the apparatus 900, in accordance with some embodiments.

FIG. 16 is an exploded bottom perspective view of the apparatus 900, in accordance with some embodiments.

FIG. 17 is an exploded front perspective view of the apparatus 900, in accordance with some embodiments.

FIG. 18 is a top perspective view of an apparatus 1800 for frangibly supporting an object to a base, in accordance with some embodiments.

FIG. 19 is a bottom perspective view of the apparatus 1800, in accordance with some embodiments.

FIG. 20 is a side perspective view of an apparatus 2000 for frangibly supporting an object to a base, in accordance with some embodiments.

FIG. 21 is a side cross sectional view of the apparatus 2000, in accordance with some embodiments.

FIG. 22 is an exploded side cross sectional view of the apparatus 2000, in accordance with some embodiments.

FIG. 23 is a side perspective view of an apparatus 2300 for frangibly supporting an object to a base, in accordance with some embodiments.

FIG. 24 is a side cross sectional view of the apparatus 2300, in accordance with some embodiments.

FIG. 25 is an exploded side cross sectional view of the apparatus 2300, in accordance with some embodiments.

FIG. 26 is an exploded top perspective view of an apparatus 2600 for frangibly supporting an object to a base, in accordance with some embodiments.

FIG. 27 is an exploded top perspective view an apparatus 2700 for frangibly supporting an object to a base, in accordance with some embodiments.

FIG. 28 is an exploded front view of the apparatus 2700, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of an apparatus for frangibly supporting an object to a base, embodiments of the present disclosure are not limited to use only in this context.

### Overview

The present disclosure describes an apparatus for frangibly supporting an object to a base. Further, the apparatus may include a reusable breakaway coupling. Further, the disclosed reusable coupling replaces single-use breakaway light couplings. Further, the reusable breakaway couplings may be used in the airport and airfield world for lighting and sign board supports near the edges of runways, taxiways, heliports, helipads, takeoff and landing zones, and other paved and unpaved surfaces within the airfield frangibility zones, airfield safety areas and object free, and other aircraft operations and parking areas designed to break away when impacted.

Further, the reusable breakaway coupling may be re-assembled in the field without the disassembly of a light fixture or associated support junction box/can. Further, coupling pieces (a lower part and an upper part) comprised in the reusable breakaway coupling may be separated in the field for a quick change of the light fixture. Further, a person (such as a technician) may separate the coupling pieces (or breakaway components) and get access to the light fixture wiring without having to open up the support junction box (or a base junction can/box). Further, the reusable breakaway coupling may be used in runway elevated guard lights, taxiway edge lights, runway edge lights or other devices requiring frangibility. Essentially, the lower part may include a bottom threaded part that allows for a standard upper breakaway component that may function with any junction can.

Further, the reusable breakaway coupling may be approved by the FAA and/or ICAO. Further, the reusable breakaway coupling may be applicable to the FAA advisory circular and frangibility requirements of (ICAO), Document 9157-AN/901, Aerodrome Design Manual, Part 6, Frangibility. Further, airport maintenance personnel (or the technicians) may benefit by having the reusable breakaway coupling so they do not constantly have to purchase new couplings every time they get impacted by an object such as a glider, a vehicle, construction equipment, a grass cutting equipment, snow, ice or snow removal equipment, etc.

Further, there may be a tendency for the upper part to fail requiring the maintenance people to not have to remove the lower part from the base junction can to save them time in the field unless there is a total failure of an overall breakaway system.

Further, in some embodiments, the reusable breakaway coupling may be applicable (or used) for roadway and mailbox applications.

Further, in some embodiments, the reusable breakaway coupling may be associated with a quick-release system made from non-conductive materials. Further, the quick-release system may be configured with an integrated system to maintain a ground connection across the reusable breakaway coupling (or breakaway coupling system).

Further, the reusable breakaway coupling may include an upper part and a lower part. Further, the upper part and the lower part may snap together in an assembled state and separate from the base when impacted while allowing the reusable breakaway coupling to be easily and quickly re-set in the field without having to replace an entire fixture (such as a light fixture post). Further, the upper part may include a plurality of upper pattern components disposed along a lower periphery of the upper part. Further, the lower part may include a plurality of lower pattern components disposed proximal to an upper periphery of the lower part. Further, the plurality of upper pattern components may include at least two of at least one projection and at least one receptacle complementary to at least two of at least one projection and at least one receptacle comprised in the plurality of lower pattern components. Further, the plurality of upper pattern components may be detachably couplable with the plurality of lower pattern components. Further, in an embodiment, a plurality of receptacles comprised in the plurality of lower pattern components may be configured for receiving a plurality of upper projections to reversibly snap-fit the lower part with the upper part. Further, the reusable breakaway couplings may be used in runway elevated guard lights, taxiway edge lights, and runway edge lights.

Further, the upper part may include a circular opening in a top surface of the upper part leading to a fixture space. Further, the fixture space may be configured for removably receiving a fixture base (such as a light fixture base, sign board fixture base, etc.) through the circular opening. Further, a hexagonal shape that allows for use with a standard wrench may characterize the upper part. Further, the upper part may include at least one threaded tap opening for receiving at least one tightening screw. Further, the at least one tightening screw may prevent sliding motion and/or wobbling of the fixture base inside the fixture space and facilitate tight fitting of the fixture base inside the upper part. Further, in an exemplary embodiment, the upper part (or upper breakaway component) may be designed to snap fit either size base coupling (2″ or 1⅛″ diameter) used throughout airfields. Further, in some embodiments, the upper part may be designed to snap fit the base coupling of a different size (or diameter). Further, in an exemplary embodiment, the lower part (or bottom portion) of the reusable breakaway coupling may be designed to fit standard threaded 2″ or 1⅛″ diameter female threaded openings in can cover plates. Further, in some embodiments, the lower part may be designed to fit a threaded female opening, of a different size (or diameter), in the can cover plates. Further, the threaded openings may allow easy changing of the lower part (or threaded bottom part) to accommodate future light can plates as needed. Further, the lower part may include a plurality of inserts for receiving a flat screwdriver or pry tool that allows for intentional separation of the reusable breakaway coupling. Further, the lower part may include standard NPT Male threads to interface with a female opening on light fixture base plates (or the can cover plates) mounted to the base junction cans (or junction cans/boxes). Further, the junction cans may be typically cylindrical and in the ground or existing pavement. Further, a top surface of the lower part may include a second circular opening leading to a lower interior space. Further, the lower part may include a lower circular opening in a lower surface of the lower part leading to the lower interior space. Further, the lower interior space may provide a passage for electrical wires required for providing power to the light fixture.

Further, the reusable breakaway coupling may be re-settable in the field. The reusable breakaway coupling may be snapped back together without having to disassemble the junction can (metal cylinder below ground or on pavement) supporting the fixture base. Further, the reusable breakaway coupling allows for disconnection of the light post fixture by releasing light fixture set screw(s) (such as the at least one tightening screw) from the fixture without having to open the junction can (or a light base junction can). Further, the reusable breakaway coupling may be used more than once and is installed with simple tools in the field.

Further, the reusable breakaway coupling may include a drip edge. Further, the drip edge keeps water from entering the top (upper) and bottom (lower) parts. The drip edge is an additional measure to help keep water out of the reusable breakaway coupling and from dripping down into the can (or base can). Further, the light can associated with the reusable breakaway coupling has rectangular notches integrated allowing the insertion of a flat screwdriver or nail clipper handle into the coupling to release the parts (upper and lower parts) without damage. Further, the reusable breakaway coupling may include a ground wire so the reusable breakaway coupling maintains the ground connection between the light fixture and the can (or base can).

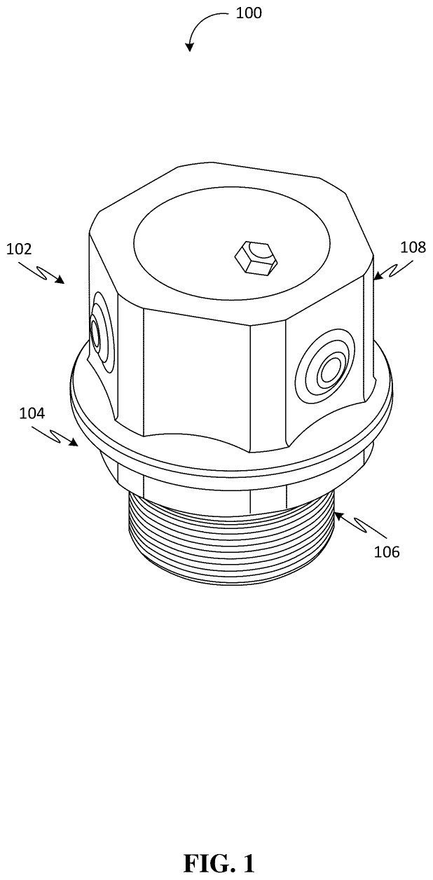

FIG. 1 is a top perspective view of an apparatus 100 for frangibly supporting an object to a base, in accordance with some embodiments. Accordingly, the apparatus 100 may include a lower part 104 and an upper part 102. Further, the apparatus 100 may include a reusable breakaway coupling.

Further, the lower part 104 may include a base coupling portion 106 and a lower engagement portion 606. Further, the lower part 104 extends between a first end 602 of the lower part 104 and a second end 604 of the lower part 104. Further, the lower engagement portion 606 extends from the first end 602 of the lower part 104 to the base coupling portion 106 and the base coupling portion 106 extends from the second end 604 of the lower part 104 to the lower engagement portion 606. Further, the base coupling portion 106 may be configured to be coupled to the base for attaching the lower part 104 to the base. Further, the base may include a junction can, a junction box, etc., having an interior space and an opening on a top side of the base leading into the interior space of the base with a base plate (or a cover plate) attached to the opening. Further, the base plate may include a hole with at least one female thread disposed on an interior surface that defines the hole. Further, the base may be installed at the edges of runways, taxiways, heliports, helipads, takeoff and landing zones, and other paved and unpaved surfaces within the airfield frangibility zones, airfield safety areas and object free, and other aircraft operations and parking areas.

Further, the upper part 102 may include an object coupling portion 108 and an upper engagement portion 612. Further, the upper part 102 extends between a first end 608 of the upper part 102 and a second end 610 of the upper part 102. Further, the object coupling portion 108 extends from the first end 608 of the upper part 102 to the upper engagement portion 612 and the upper engagement portion 612 extends from the second end 610 of the upper part 102 to the object coupling portion 108. Further, the object coupling portion 108 may be configured to be coupled to the object for attaching the object to the upper part 102. Further, the upper engagement portion 612 may be configured to be disengageably engaged with the lower engagement portion 606 for decouplably coupling the upper part 102 with the lower part 104. Further, the upper engagement portion 612 may be configured to be reengaged with the lower engagement portion 606 for recoupling the upper part 102 with the lower part 104. Further, a shape of at least a portion of the upper engagement portion 612 complements a shape of at least a portion of the lower engagement portion 606. Further, the engaging of the upper engagement portion 612 with the lower engagement portion 606 may be based on at least one engaging action applied to the upper part 102 in relation to the lower part 104 for the coupling of the upper part 102 with the lower part 104. Further, the coupling of the upper part 102 with the lower part 104 may include mechanically coupling of the upper part 102 with the lower part 104. Further, the at least one engaging action may be applied after aligning the second end 610 of the upper part 102 with the first end 602 of the lower part 104. Further, an outer surface of the apparatus may include at least one aligning indication for facilitating the aligning. Further, the second end 610 of the upper part 102 juxtaposes the first end 602 of the lower part 104. Further, the disengaging of the upper engagement portion 612 from the lower engagement portion 606 may be based on at least one disengaging action applied to the upper part 102 in relation to the lower part 104 for decoupling the upper part 102 from the lower part 104. Further, the reengaging of the upper engagement portion 612 with the lower engagement portion 606 may be based on at least one reengaging action applied to the upper part 102 in relation to the lower part 104 for the recoupling of the upper part 102 with the lower part 104 after the disengaging. Further, the at least one reengaging action may be applied after aligning the second end 610 of the upper part 102 with the first end 602 of the lower part 104. Further, the upper engagement portion 612 may be configured for transitioning from a disengaged state to an engaged state based on the applying of the at least one engaging action for the engaging. Further, the upper engagement portion 612 may be configured for transitioning from the engaged state to the disengaged state based on the applying of the at least one disengaging action for the disengaging. Further, the at least one engaging action, the at least one disengaging action, and the at least one reengaging action may be applied by at least one user exerting at least one manual force to the upper part 102 directly, the at least one user exerting at least one manual force using at least one tool, etc. Further, the at least one disengaging action may be applied by at least one external object imparting at least one force on the upper part 102 based on an impact imparted to the apparatus 100 by the at least one external object. Further, the object may include a lighting (or light) fixture, a signboard fixture, etc. Further, the frangibly supporting allows for disassembling of the upper part 102 from the lower part 104 based on the decouplably coupling. Further, the upper part 102 may be recoupled to the lower part 104 allowing reusability of the apparatus 100.

Further, in some embodiments, the base coupling portion 106 may include at least one male thread 704-708 disposed on an outer surface 702 of the base coupling portion 106. Further, the base may include a hole comprising at least one female thread disposed on an inner surface of the hole. Further, the at least one male thread 704-708 may be threadedly coupled to the at least one female thread for the coupling of the base coupling portion 106 to the base. Further, the base coupling portion 106 may be cylindrically shaped. Further, the base coupling portion 106 may be associated with a diameter allowing the base coupling portion 106 to fit the hole having 2 inches diameter, 1⅛ inches diameter, etc.

Further, in some embodiments, the object coupling portion 108 may include an interior space 614 and an opening 616 leading into the interior space 614. Further, the opening 616 may be circularly shaped. Further, the interior space 614 extends axially along a central axis of the object coupling portion 108. Further, the first end 608 of the upper part 102 defines the opening 616. Further, the object coupling portion 108 may be configured for receiving at least a portion of the object into the interior space 614 through the opening 616. Further, the coupling of the object to the object coupling portion 108 may be based on the receiving. Further, at least the portion of the object may include a base of the lighting (or light) fixture, the signboard fixture, etc. Further, the base of the lighting (or light) fixture, the signboard fixture, etc., may be a cylindrical shaft. Further, a diameter of the cylindrical shaft may be less than equal to a diameter of the opening 616.

Further, in an embodiment, the object coupling portion 108 may include at least one hole 618-622 extending from an outer surface 624 of the object coupling portion 108 to an inner surface 626 of the object coupling portion 108. Further, the at least one hole 618-622 may be threaded. Further, the at least one hole 618-622 radially extends from the outer surface 624 to the inner surface 626 in relation to the central axis. Further, the inner surface 626 defines the interior space 614. Further, the at least one hole 618-622 may be engageable with at least one fastening element. Further, the at least one fastening element may include at least one tightening screw with threads for threadedly engaging with the at least one hole 618-622. Further, the at least one fastening element may be transitionable between a fastened position and at least one unfastened position after the engaging of the at least one fastening element with the at least one hole 618-622. Further, the at least one fastening element fastens at least the portion of the object to the object coupling portion 108 in the fastened position. Further, the at least one fastening element unfastens at least the portion of the object from the object coupling portion 108 in the at least one unfastened position.

Further, in some embodiments, the object coupling portion 108 may include an outer surface 624 comprised of a plurality of facets 628-632 forming at least one polygonal shape. Further, the at least one polygonal shape may include a hexagonal shape. Further, the hexagonal shape allows an interfacing of the outer surface 624 with a wrench. Further, the wrench allows rotating the apparatus 100 when the upper engagement portion 612 may be in the engaged state between an uncoupled position to at least one coupled position for threadedly coupling the base coupling portion 106 to the base. Further, the threadedly coupling secures the apparatus 100 to the base.

Further, in some embodiments, the upper engagement portion 612 may include at least one of at least one first protrusion 710-712 and at least one first recess 714 arranged in at least one first configuration. Further, the at least one first recess 714 may be defined adjacent to the at least one first protrusion 710-712. Further, the lower engagement portion 606 may include at least one second recess 634 and at least one second protrusion 636-638 arranged in at least one second configuration. Further, the lower engagement portion 606 may include an inner surface defining the at least one second recess 634. Further, the at least one second protrusion 636-638 may extend from the inner surface of the lower engagement portion 606. Further, at least one of the at least one first protrusion 710-712 and the at least one first recess 714 in the at least one first configuration complements at least one of the at least one second recess 634 and the at least one second protrusion 636-638 in the at least one second configuration. Further, the at least one first protrusion 710-712 disengageably engages with the at least one second recess 634 and the at least one second protrusion 636-638 disengageably engages with the at least one first recess 714 for the disengageably engaging the upper engagement portion 612 with the lower engagement portion 606. Further, at least one of the at least one first protrusion 710-712 and the at least one first recess 714 in the at least one first configuration engages with at least one of the at least one second recess 634 and the at least one second protrusion 636-638 in the at least one second configuration using an interference fit, a snap fit, etc. Further, at least one of the at least one first protrusion 710-712 and the at least one first recess 714 may include at least one first locking feature and at least one of the at least one second recess 634 and the at least one second protrusion 636-638 may include at least one second locking feature corresponding to the at least one first locking feature. Further, the at least one first locking feature engages with the at least one second locking feature for preventing unintentional decoupling of the upper part 102 from the lower part 104. Further, in an embodiment, the at least one first protrusion 710-712 may be comprised of at least one flexibly resilient material (such as thermoplastic material). Further, the at least one first protrusion 710-712 may be transitionable between an undeformed state and at least one elastically deformed state. Further, the engaging of at least one of the at least one first protrusion 710-712 and the at least one first recess 714 in the at least one first configuration with at least one of the at least one second recess 634 and the at least one second protrusion 636-638 in the at least one second configuration transitions the at least one first protrusion 710-712 from the undeformed state to the at least one elastically deformed state. Further, an outer surface of the at least one first protrusion 710-712 exerts at least one force on an inner surface of the at least one second recess 634 in the at least one elastically deformed state for the coupling of the upper part 102 with the lower part 104.

Further, in some embodiments, the upper part 102 may include a skirting 640 disposed on an outer surface 624 of the object coupling portion 108 around the object coupling portion 108. Further, the skirting 640 extends away from the outer surface 624. Further, the skirting 640 covers at least a portion of the upper engagement portion 612 and the lower engagement portion 606 for protecting at least the portion of the upper engagement portion 612 and the lower engagement portion 606 from at least one external element. Further, the skirting 640 may include an edge guard. Further, the at least one external element may include water from rain, etc.

Further, in some embodiments, the lower engagement portion 606 may include an outer surface 642 comprised of a plurality of facets 644-648 forming at least one polygonal shape. Further, the at least one polygonal shape may include a hexagonal shape. Further, the hexagonal shape allows an interfacing of the outer surface 642 with a wrench. Further, the wrench allows rotating the apparatus 100 when the upper engagement portion 612 may be in the engaged state between an uncoupled position to at least one coupled position for threadedly coupling the base coupling portion 106 to the base. Further, the threadedly coupling secures the apparatus 100 to the base.

Further, in some embodiments, the lower part 104 may include at least one passage 502-506. Further, the at least one passage 502-506 may include at least one insert. Further, the at least one passage 502-504 may be configured for receiving at least one tool in the at least one passage 502-504. Further, the at least one tool may include a flat head screwdriver, a pry tool, etc. Further, the at least one tool accesses at least one of the upper engagement portion 612 and the lower engagement portion 606 based on the receiving. Further, the at least tool applies at least one external action on at least one of the upper engagement portion 612 and the lower engagement portion 606 for the disengaging the upper engagement portion 612 from the lower engagement portion 606 based on the accessing.

Further, in some embodiments, the upper part 102 may include a first internal cavity 650 extending from a first end 608 of the upper part 102 to a second end 610 of the upper part 102. Further, the lower part 104 may include a second internal cavity 652 extending from a first end 602 of the lower part 104 to a second end 604 of the lower part 104. Further, the first internal cavity 650 extends axially along a length of the upper part 102 defined between the first end 608 of the upper part 102 and the second end 610 of the upper part 102. Further, the second internal cavity 652 extends axially along a length of the lower part 104 defined between the first end 602 of the lower part 104 and the second end 604 of the lower part 104. Further, the first cavity couples with the second cavity based on the coupling of the upper part 102 with the lower part 104 forming an internal cavity of the apparatus 100.

Further, in an embodiment, the apparatus 100 may be comprised of at least one flexibly resilient material (such as thermoplastic material).

Further, in an embodiment, a width of the top part 102 may be 3 inches, a length of the apparatus 100 may be 4 inches, a diameter of the opening 616 may be 2.3 inches, and a diameter of an internal cavity of the apparatus 100 may be 1.6 inches.

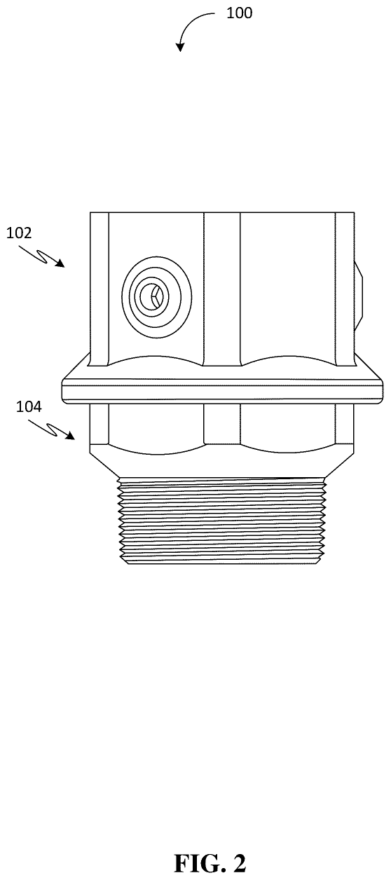

FIG. 2 is a front view of the apparatus 100, in accordance with some embodiments.

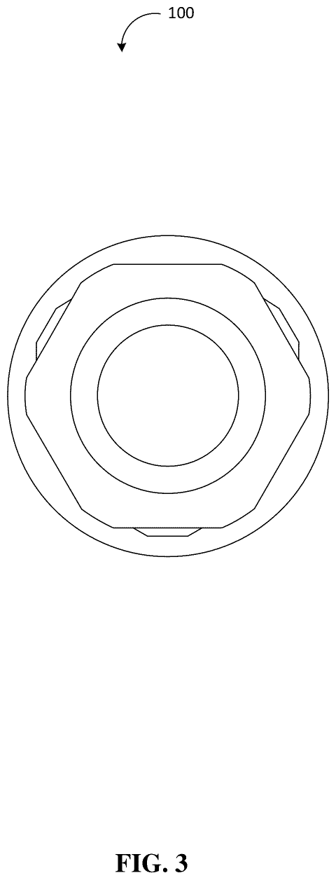

FIG. 3 is a top view of the apparatus 100, in accordance with some embodiments.

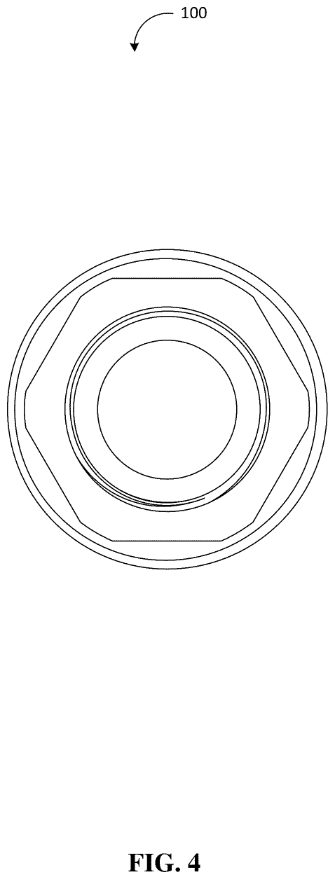

FIG. 4 is a bottom view of the apparatus 100, in accordance with some embodiments.

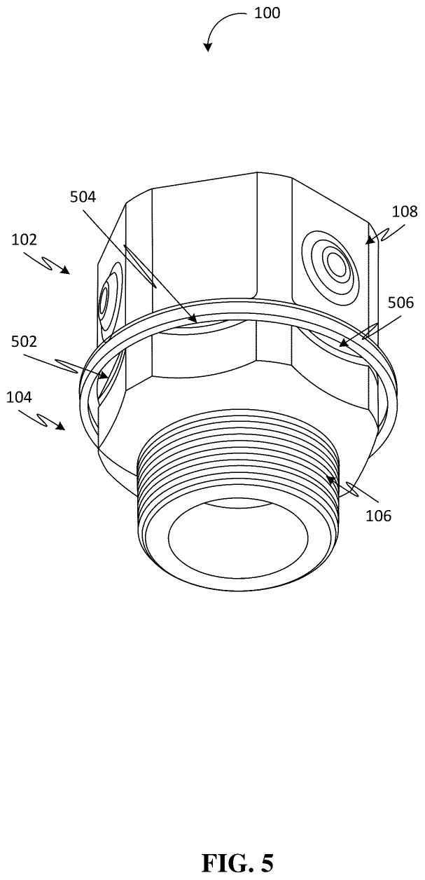

FIG. 5 is a bottom perspective view of the apparatus 100, in accordance with some embodiments.

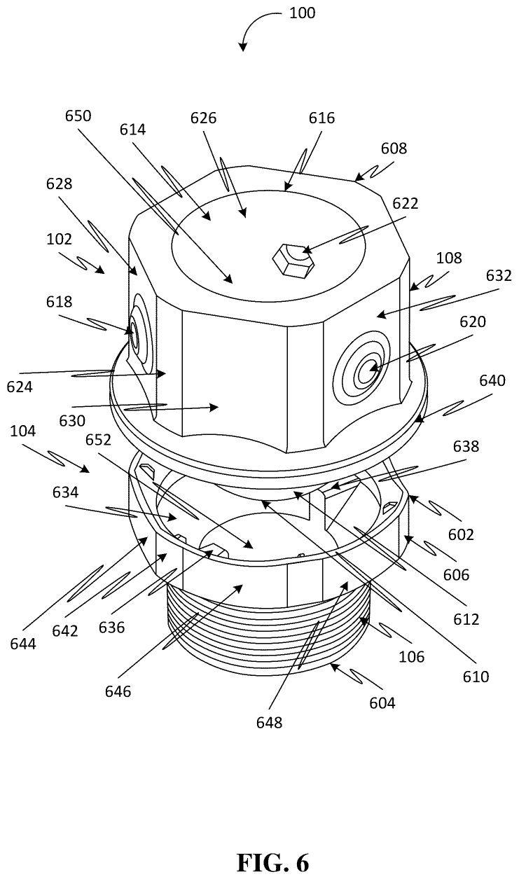

FIG. 6 is an exploded top perspective view of the apparatus 100, in accordance with some embodiments.

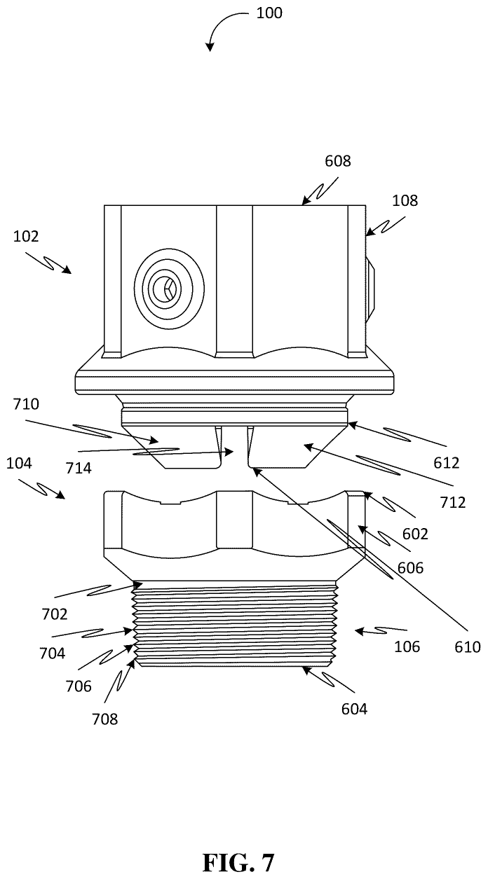

FIG. 7 is an exploded front perspective view of the apparatus 100, in accordance with some embodiments.

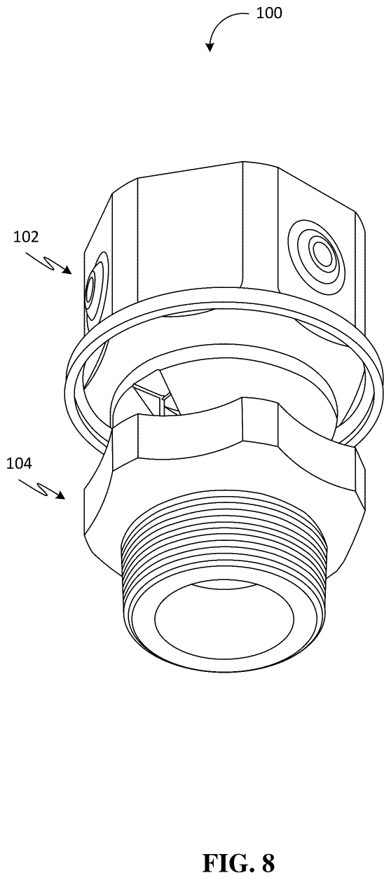

FIG. 8 is an exploded bottom perspective view of the apparatus 100, in accordance with some embodiments. Further, the object may include a runway edge light. Further, the apparatus 100 may frangibly support the runway edge light.

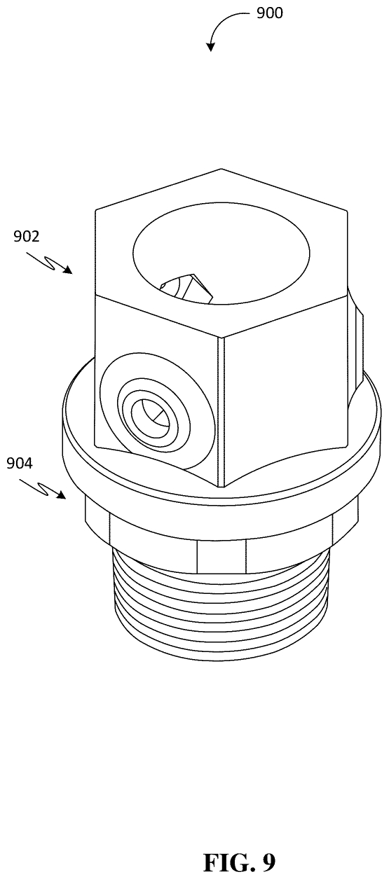

FIG. 9 is a top perspective view of an apparatus 900 for frangibly supporting an object to a base, in accordance with some embodiments. Accordingly, the apparatus 900 may include a lower part 904 and an upper part 902. Further, the object may include a taxiway edge light. Further, the apparatus 900 may be a reusable breakaway coupling for frangibly supporting the taxiway edge light.

Further, in an embodiment, a width of the top part 902 may be 1.75 inches, a length of the apparatus 900 may be 2.95 inches, a diameter of an opening disposed on a first end of the top part 902 may be 1.22 inches, a diameter of a skirting (or edge guard) may be 2.2 inches, and a diameter of the bottom part 902 at a second end may be 1.53 inches, a width of the bottom part 904 at a first end may be 1.88 inches, and a diameter of an internal cavity of the apparatus 900 may be 1.06 inches.

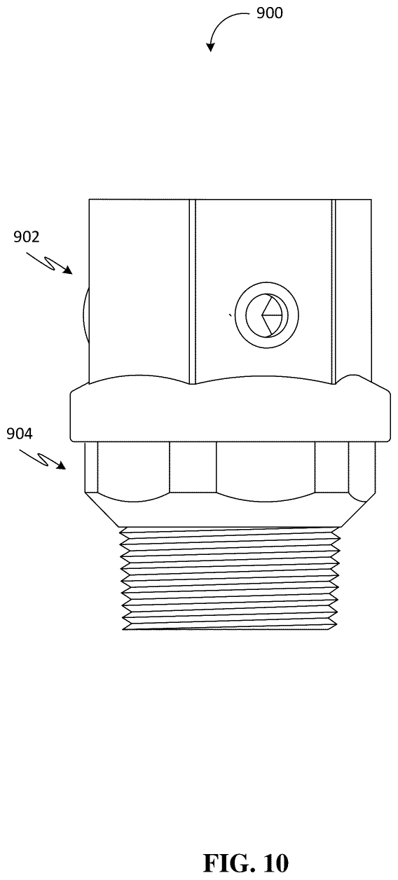

FIG. 10 is a front view of the apparatus 900, in accordance with some embodiments.

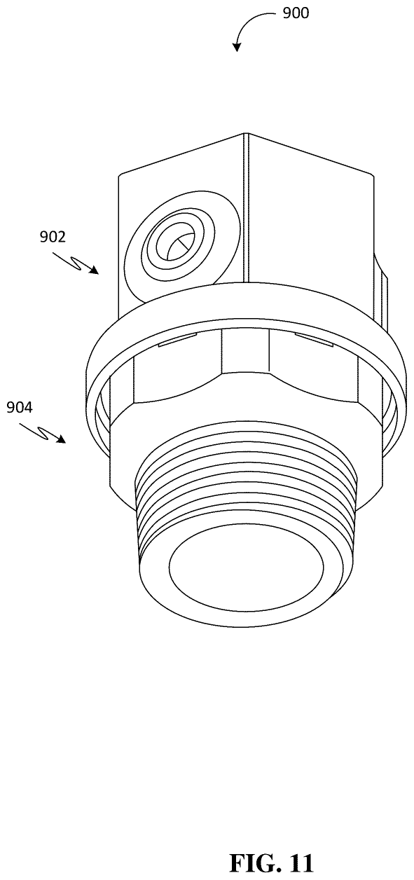

FIG. 11 is a bottom perspective view of the apparatus 900, in accordance with some embodiments.

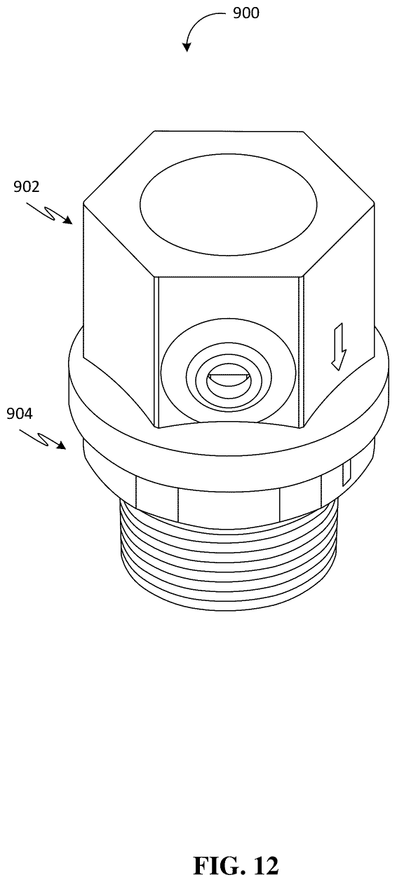

FIG. 12 is a left side top perspective view of the apparatus 900, in accordance with some embodiments.

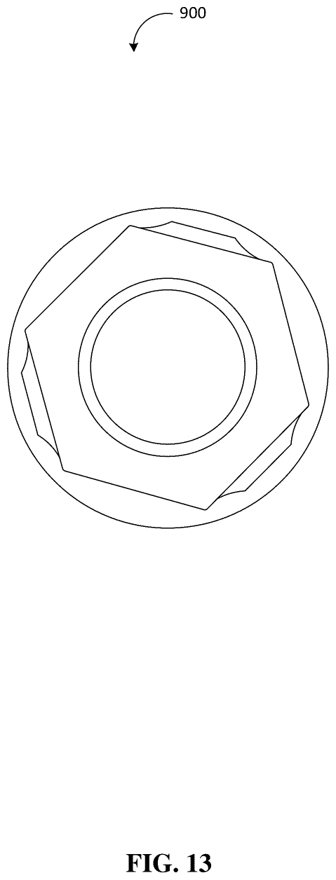

FIG. 13 is a top view of the apparatus 900, in accordance with some embodiments.

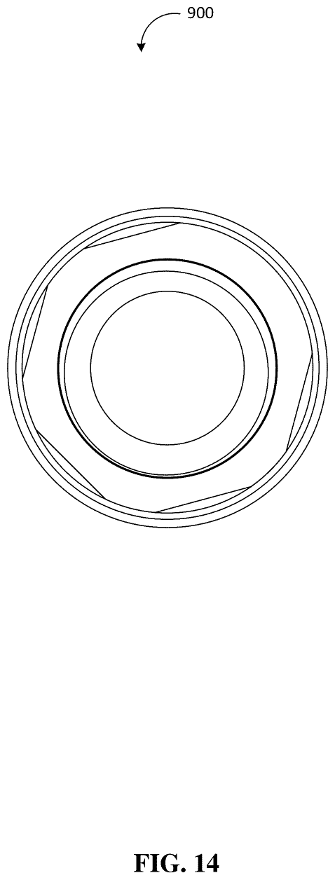

FIG. 14 is a bottom view of the apparatus 900, in accordance with some embodiments.

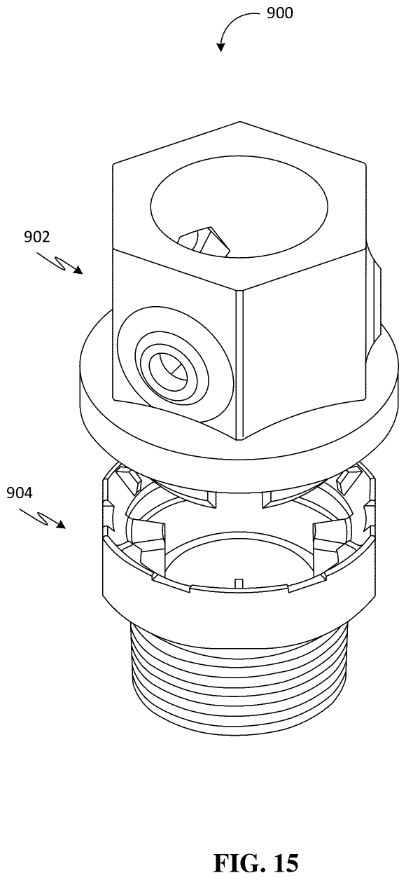

FIG. 15 is an exploded top perspective view of the apparatus 900, in accordance with some embodiments.

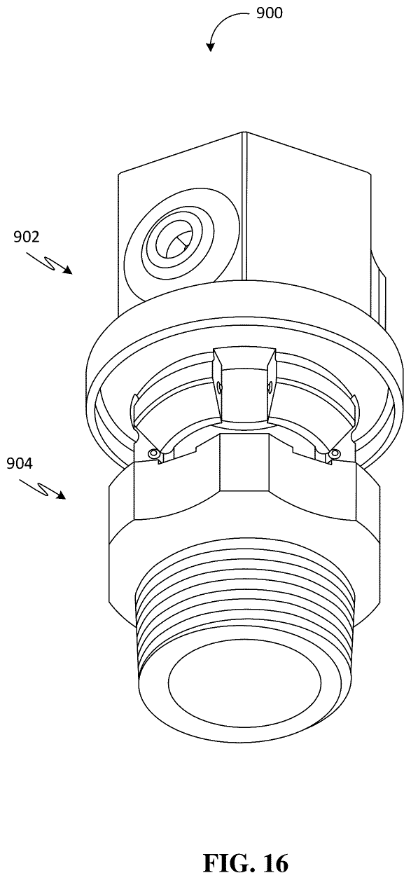

FIG. 16 is an exploded bottom perspective view of the apparatus 900, in accordance with some embodiments.

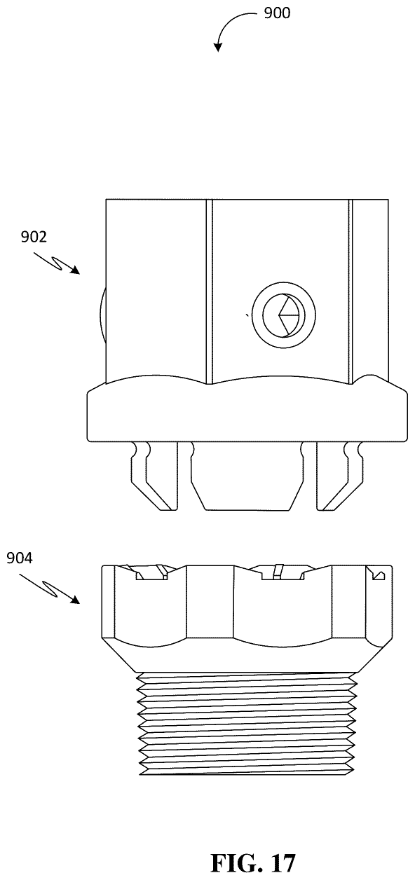

FIG. 17 is an exploded front perspective view of the apparatus 900, in accordance with some embodiments.

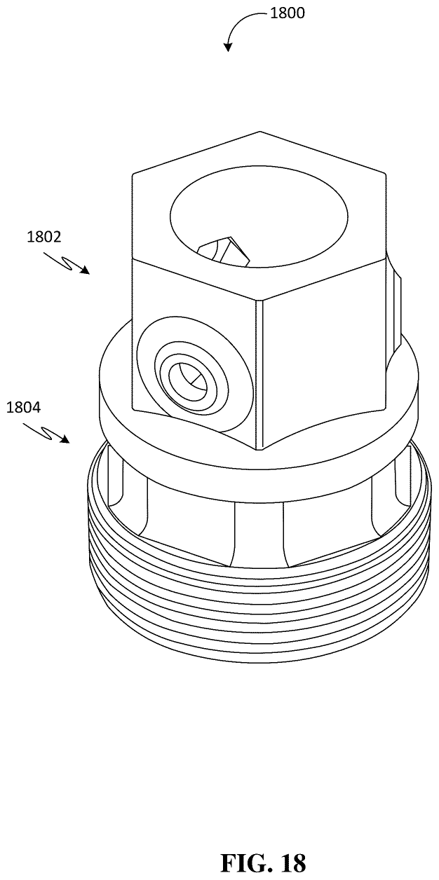

FIG. 18 is a top perspective view of an apparatus 1800 for frangibly supporting an object to a base, in accordance with some embodiments. Accordingly, the apparatus 1800 may include a lower part 1804 and an upper part 1802. Further, the object may include a taxiway edge light Further, the apparatus 1800 may be a reusable breakaway coupling for frangibly supporting the taxiway edge light.

Further, in an embodiment, a width of the top part 1802 may be 1.75 inches, a length of the apparatus 1800 may be 2.95 inches, a diameter of an opening disposed on a first end of the top part 1802 may be 1.22 inches, a diameter of a skirting (or edge guard) may be 2.2 inches, and a diameter of the bottom part 1802 at a second end may be 2.3 inches, a width of the bottom part 1804 at a first end may be 1.88 inches, and a diameter of an internal cavity of the apparatus 1800 may be 1.06 inches.

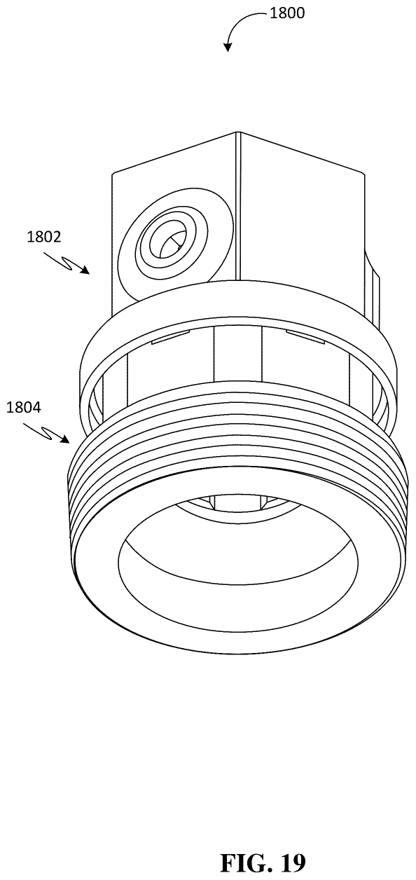

FIG. 19 is a bottom perspective view of the apparatus 1800, in accordance with some embodiments.

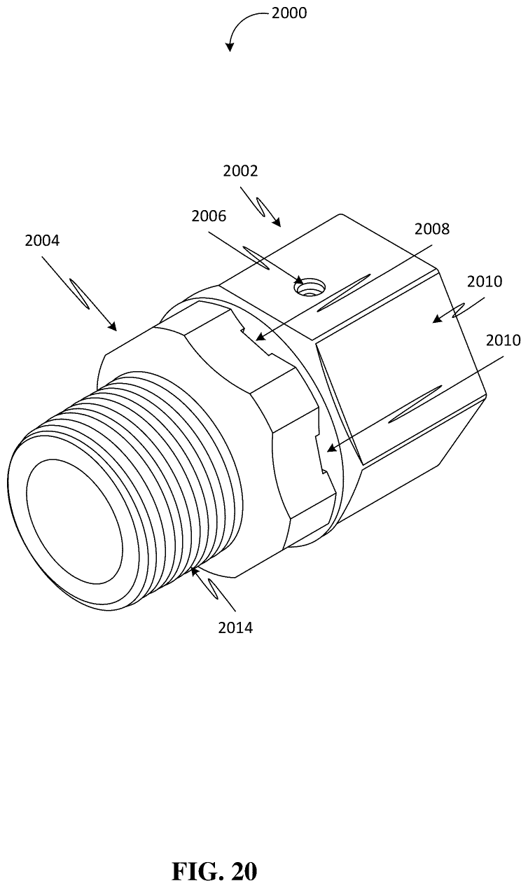

FIG. 20 is a side perspective view of an apparatus 2000 for frangibly supporting an object to a base, in accordance with some embodiments. Further, the apparatus 2000 may include an upper part 2002 and a lower part 2004. Further, the apparatus 2000 may include at least one threaded hole 2006 disposed in the upper part 2002. Further, the upper part 2002 may include at least one first cutaway and the lower part 2004 may include at least one second cutaway corresponding to the at least one first cutaway. Further, the at least one first cutaway juxtaposes the at least one second cutaway based on a coupling of the upper part 2002 and the lower part 2004 to form at least one inserting gap 2008-2010 along a coupling plane for the coupling. Further, the at least inserting gap 2008-2010 allows inserting at least one tool in the at least one inserting gap 2008-2010 for applying at least one action to at least one of the upper part 2002 and the lower part 2004 for intentionally decoupling the upper part 2002 from the lower part 2004 along the coupling plane. Further, the upper part may include a multi faceted outer surface 2012. Further, the multi faceted outer surface 2012 may be hexagonally shaped. Further, the lower part 2004 may include a plurality of male threads 2014.

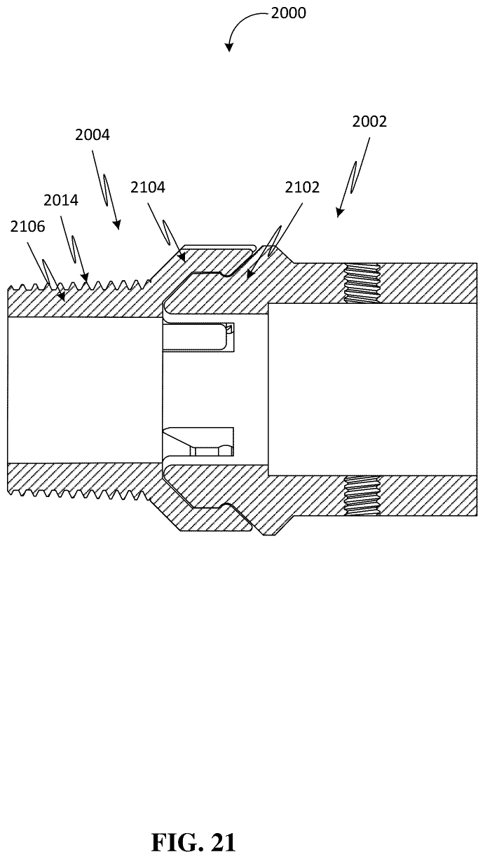

FIG. 21 is a side cross sectional view of the apparatus 2000, in accordance with some embodiments. Further, the upper part 2002 may include an upper engagement portion 2102 and the lower part 2004 may include a lower engagement portion 2104. Further, the upper engagement portion 2102 may be disengageably engageable to the lower engagement portion 2104 for decouplably coupling the upper part 2002 with the bottom part 2004. Further, the lower part 2004 may include a base coupling portion 2106 extending from the lower engagement portion 2104. Further, the plurality of male threads 2014 may be disposed on an exterior of the base coupling portion 2106. Further, the base coupling portion 2106 may be cylindrically shaped. Further, the base coupling portion 2106 may be associated with a first diameter.

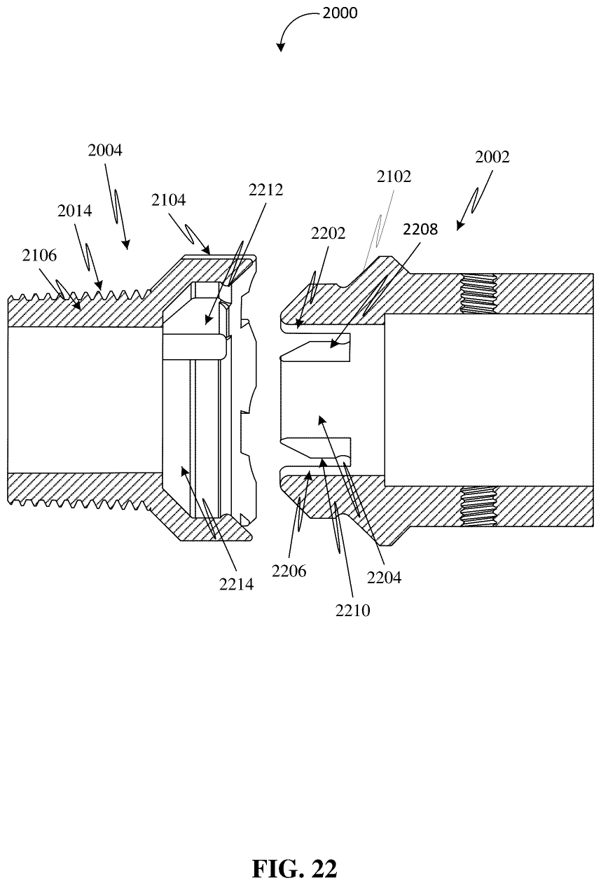

FIG. 22 is an exploded side cross sectional view of the apparatus 2000, in accordance with some embodiments. Further, the upper engagement portion 2102 may include at least one first protrusion 2202-2206 and at least one first recess 2208-2210 and the lower engagement portion 2104 may include at least one second protrusion 2212 and at least one second recess 2214. Further, the at least one first protrusion 2202-2206 complements the at least one second recess 2214 and the at least one first recess 2208-2210 complements the at least one second protrusion 2212.

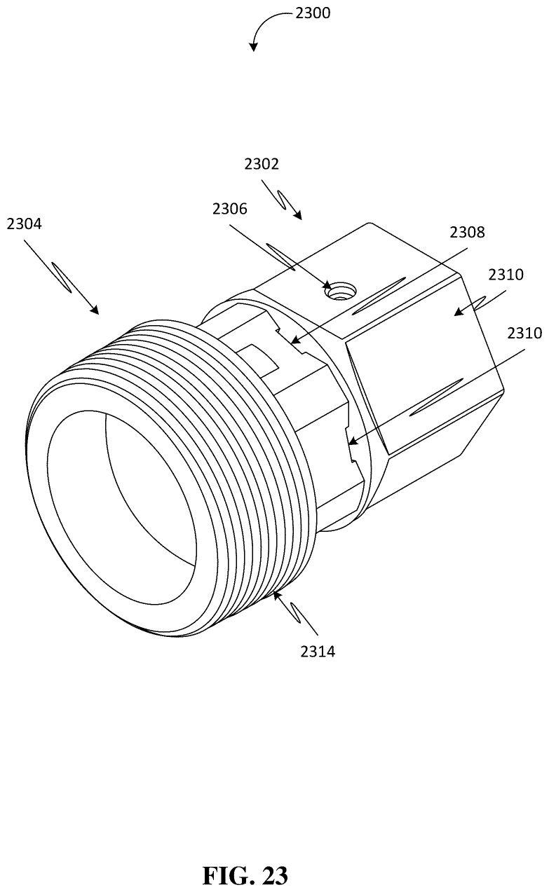

FIG. 23 is a side perspective view of an apparatus 2300 for frangibly supporting an object to a base, in accordance with some embodiments. Further, the apparatus 2300 may include an upper part 2302 and a lower part 2304. Further, the apparatus 2300 may include at least one threaded hole 2306 disposed in the upper part 2302. Further, the upper part 2302 may include at least one first cutaway and the lower part 2304 may include at least one second cutaway corresponding to the at least one first cutaway. Further, the at least one first cutaway juxtaposes the at least one second cutaway based on a coupling of the upper part 2302 and the lower part 2304 to form at least one inserting gap 2308-2310 along a coupling plane for the coupling. Further, the at least inserting gap 2308-2310 allows inserting at least one tool in the at least one inserting gap 2308-2310 for applying at least one action to at least one of the upper part 2302 and the lower part 2304 for intentionally decoupling the upper part 2302 from the lower part 2304 along the coupling plane. Further, the upper part may include a multi faceted outer surface 2312. Further, the multi faceted outer surface 2312 may be hexagonally shaped. Further, the lower part 2304 may include a plurality of male threads 2314.

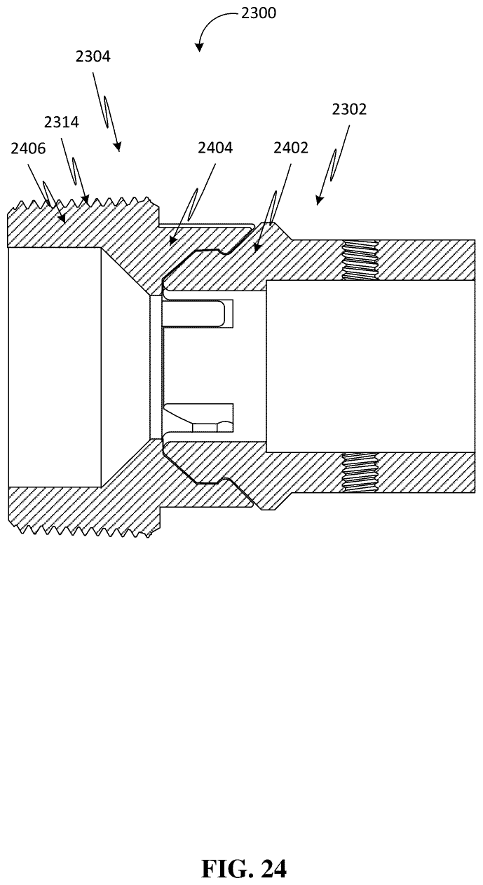

FIG. 24 is a side cross sectional view of the apparatus 2300, in accordance with some embodiments. Further, the upper part 2302 may include an upper engagement portion 2402 and the lower part 2304 may include a lower engagement portion 2404. Further, the upper engagement portion 2402 may be disengageably engageable to the lower engagement portion 2404 for decouplably coupling the upper part 2302 with the bottom part 2304. Further, the lower part 2304 may include a base coupling portion 2406 extending from the lower engagement portion 2404. Further, the plurality of male threads 2314 may be disposed on an exterior of the base coupling portion 2406. Further, the base coupling portion 2406 may be cylindrically shaped. Further, the base coupling portion 2406 may be associated with a second diameter. Further, the second diameter may be greater than the first diameter.

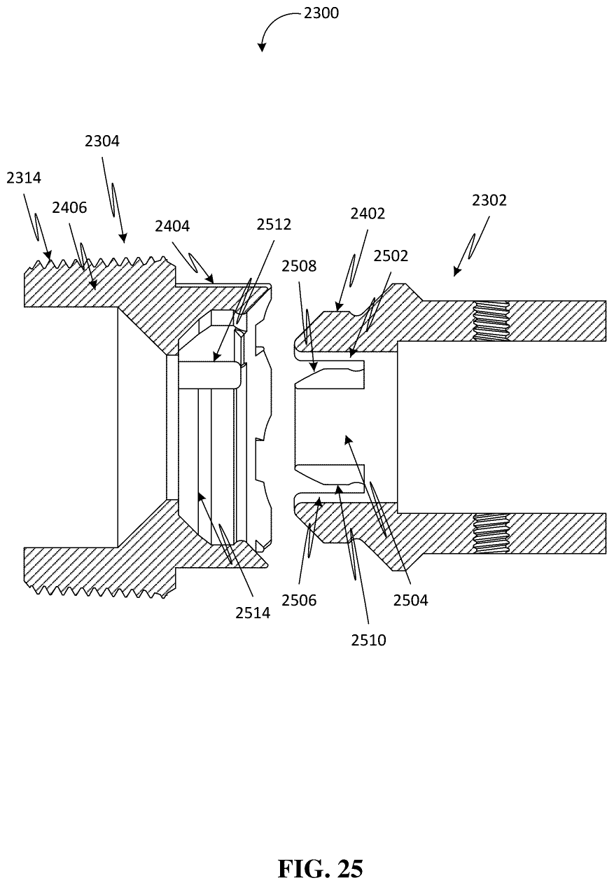

FIG. 25 is an exploded side cross sectional view of the apparatus 2300, in accordance with some embodiments. Further, the upper engagement portion 2402 may include at least one first protrusion 2502-2506 and at least one first recess 2508-2510 and the lower engagement portion 2404 may include at least one second protrusion 2512 and at least one second recess 2514. Further, the at least one first protrusion 2502-2506 complements the at least one second recess 2514 and the at least one first recess 2508-2510 complements the at least one second protrusion 2512.

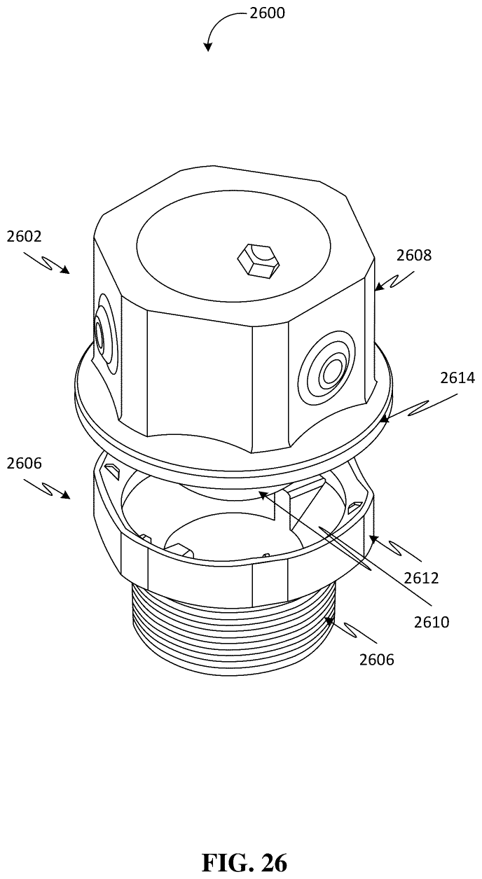

FIG. 26 is an exploded top perspective view of an apparatus 2600 for frangibly supporting an object to a base, in accordance with some embodiments. Accordingly, the apparatus 2600 may include a lower part 2604 and an upper part 2602.

Further, the lower part 2604 may include a base coupling portion 2606 and a lower engagement portion 2612. Further, the base coupling portion 2606 may be configured to be coupled to the base for attaching the lower part 2604 to the base.

Further, the upper part 2602 may include an object coupling portion 2608 and an upper engagement portion 2610. Further, the object coupling portion 2608 may be configured to be coupled to the object for attaching the object to the upper part 2602. Further, the upper engagement portion 2610 may be configured to be disengageably engaged with the lower engagement portion 2612 for decouplably coupling the upper part 2602 with the lower part 2604. Further, a shape of at least a portion of the upper engagement portion 2610 complements a shape of at least a portion of the lower engagement portion 2612. Further, the engaging of the upper engagement portion 2610 with the lower engagement portion 2612 may be based on at least one engaging action applied to the upper part 2602 in relation to the lower part 2604 for the coupling of the upper part 2602 with the lower part 2604. Further, the disengaging of the upper engagement portion 2610 from the lower engagement portion 2612 may be based on at least one disengaging action applied to the upper part 2602 in relation to the lower part 2604 for decoupling the upper part 2602 from the lower part 2604. Further, the upper engagement portion 2610 may be configured for transitioning from a disengaged state to an engaged state based on the applying of the at least one engaging action for the engaging. Further, the upper engagement portion 2610 may be configured for transitioning from the engaged state to the disengaged state based on the applying of the at least one disengaging action for the disengaging. Further, the upper part 2602 may include a skirting 2614 disposed on an outer surface of the object coupling portion 2608 around the object coupling portion 2608. Further, the skirting 2614 extends away from the outer surface. Further, the skirting 2614 covers at least a portion of the upper engagement portion 2610 and the lower engagement portion 2612 for protecting at least the portion of the upper engagement portion 2610 and the lower engagement portion 2612 from at least one external element.

Further, in some embodiments, the base coupling portion 2606 may include at least one male thread disposed on an outer surface of the base coupling portion 2606. Further, the base may include a hole comprising at least one female thread disposed on an inner surface of the hole. Further, the at least one male thread may be threadedly coupled to the at least one female thread for the coupling of the base coupling portion 2606 to the base.

Further, in some embodiments, the object coupling portion 2608 may include an interior space and an opening leading into the interior space. Further, the object coupling portion 2608 may be configured for receiving at least a portion of the object into the interior space through the opening. Further, the coupling of the object to the object coupling portion 2608 may be based on the receiving.

Further, in an embodiment, the object coupling portion 2608 may include at least one hole extending from an outer surface of the object coupling portion 2608 to an inner surface of the object coupling portion 2608. Further, the inner surface defines the interior space. Further, the at least one hole may be engageable with at least one fastening element. Further, the at least one fastening element may be transitionable between a fastened position and at least one unfastened position after the engaging of the at least one fastening element with the at least one hole. Further, the at least one fastening element fastens at least the portion of the object to the object coupling portion 2608 in the fastened position. Further, the at least one fastening element unfastens at least the portion of the object from the object coupling portion 2608 in the at least one unfastened position.

Further, in some embodiments, the object coupling portion 2608 may include an outer surface comprised of a plurality of facets forming at least one polygonal shape.

Further, in some embodiments, the upper engagement portion 2610 may include at least one of at least one first protrusion and at least one first recess arranged in at least one first configuration. Further, the lower engagement portion 2612 may include at least one second recess and at least one second protrusion arranged in at least one second configuration. Further, at least one of the at least one first protrusion and the at least one first recess in the at least one first configuration complements at least one of the at least one second recess and the at least one second protrusion in the at least one second configuration. Further, the at least one first protrusion disengageably engages with the at least one second recess and the at least one second protrusion disengageably engages with the at least one first recess for the disengageably engaging the upper engagement portion 2610 with the lower engagement portion 2612.

Further, in some embodiments, the lower engagement portion 2612 may include an outer surface comprised of a plurality of facets forming at least one polygonal shape.

Further, in some embodiments, the lower part 2604 may include at least one passage. Further, the at least one passage may be configured for receiving at least one tool in the at least one passage. Further, the at least one tool accesses at least one of the upper engagement portion 2610 and the lower engagement portion 2612 based on the receiving. Further, the at least tool applies at least one external action on at least one of the upper engagement portion 2610 and the lower engagement portion 2612 for the disengaging the upper engagement portion 2610 from the lower engagement portion 2612 based on the accessing.

Further, in some embodiments, the upper part 2602 may include a first internal cavity extending from a first end of the upper part 2602 to a second end of the upper part 2602. Further, the lower part 2604 may include a second internal cavity extending from a first end of the lower part 2604 to a second end of the lower part 2604. Further, the first cavity couples with the second cavity based on the coupling of the upper part 2602 with the lower part 2604 forming an internal cavity of the apparatus 2600.

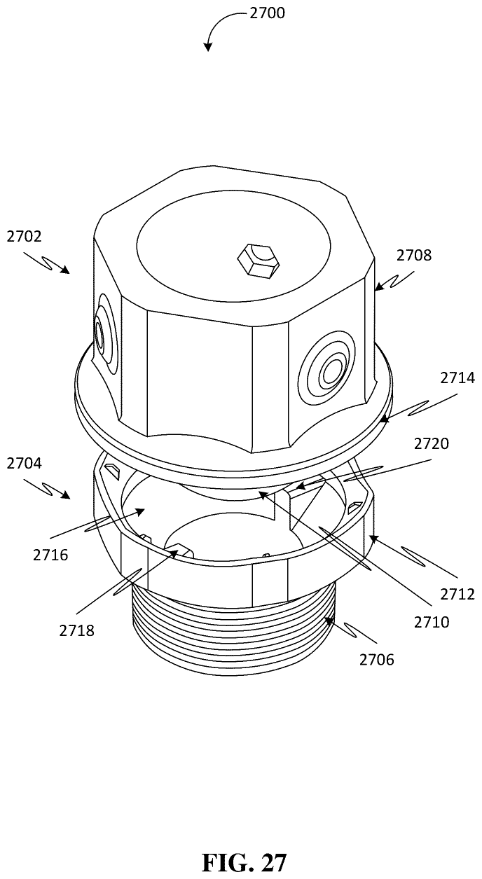

FIG. 27 is an exploded top perspective view an apparatus 2700 for frangibly supporting an object to a base, in accordance with some embodiments. Accordingly, the apparatus 2700 may include a lower part 2704 and an upper part 2702.

Further, the lower part 2704 may include a base coupling portion 2706 and a lower engagement portion 2712. Further, the base coupling portion 2706 may be configured to be coupled to the base for attaching the lower part 2704 to the base.

Further, the upper part 2702 may include an object coupling portion 2708 and an upper engagement portion 2710. Further, the object coupling portion 2708 may be configured to be coupled to the object for attaching the object to the upper part 2702. Further, the upper engagement portion 2710 may be configured to be disengageably engaged with the lower engagement portion 2712 for decouplably coupling the upper part 2702 with the lower part 2704. Further, a shape of at least a portion of the upper engagement portion 2710 complements a shape of at least a portion of the lower engagement portion 2712. Further, the engaging of the upper engagement portion 2710 with the lower engagement portion 2712 may be based on at least one engaging action applied to the upper part 2702 in relation to the lower part 2704 for the coupling of the upper part 2702 with the lower part 2704. Further, the disengaging of the upper engagement portion 2710 from the lower engagement portion 2712 may be based on at least one disengaging action applied to the upper part 2702 in relation to the lower part 2704 for decoupling the upper part 2702 from the lower part 2704. Further, the upper engagement portion 2710 may be configured for transitioning from a disengaged state to an engaged state based on the applying of the at least one engaging action for the engaging. Further, the upper engagement portion 2710 may be configured for transitioning from the engaged state to the disengaged state based on the applying of the at least one disengaging action for the disengaging. Further, the upper engagement portion 2710 may include at least one of at least one first protrusion 2802-2804 and at least one first recess 2806 arranged in at least one first configuration. Further, the lower engagement portion 2712 may include at least one second recess 2716 and at least one second protrusion 2718-2720 arranged in at least one second configuration. Further, at least one of the at least one first protrusion 2802-2804 and the at least one first recess 2806 in the at least one first configuration complements at least one of the at least one second recess 2716 and the at least one second protrusion 2718-2720 in the at least one second configuration. Further, the at least one first protrusion 2802-2804 disengageably engages with the at least one second recess 2716 and the at least one second protrusion 2718-2720 disengageably engages with the at least one first recess 2806 for the disengageably engaging the upper engagement portion 2710 with the lower engagement portion 2712. Further, the upper part 2702 may include a skirting 2714 disposed on an outer surface of the object coupling portion 2708 around the object coupling portion 2708. Further, the skirting 2714 extends away from the outer surface. Further, the skirting 2714 covers at least a portion of the upper engagement portion 2710 and the lower engagement portion 2712 for protecting at least the portion of the upper engagement portion 2710 and the lower engagement portion 2712 from at least one external element.

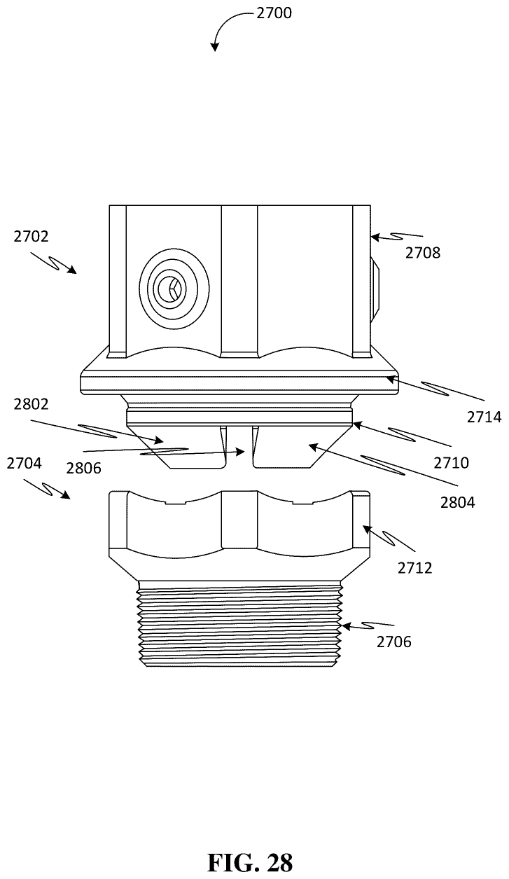

FIG. 28 is an exploded front view of the apparatus 2700, in accordance with some embodiments.

Although the present disclosure has been explained in relation to its preferred embodiment, it is to be understood that many other possible modifications and variations can be made without departing from the spirit and scope of the disclosure.

What is claimed is:

1. An apparatus for frangibly supporting an object to a base, the apparatus comprising:
a lower part comprising a base coupling portion and a lower engagement portion, wherein the base coupling portion is configured to be coupled to the base for attaching the lower part to the base; and
an upper part comprising an object coupling portion and an upper engagement portion, wherein the object coupling portion is configured to be coupled to the object for attaching the object to the upper part, wherein the upper engagement portion is configured to be disengageably engaged with the lower engagement portion for decouplably coupling the upper part with the lower part, wherein a shape of at least a portion of the upper engagement portion complements a shape of at least a portion of the lower engagement portion, wherein the engaging of the upper engagement portion with the lower engagement portion is based on at least one engaging action applied to the upper part in relation to the lower part for the coupling of the upper part with the lower part, wherein the disengaging of the upper engagement portion from the lower engagement portion is based on at least one disengaging action applied to the upper part in relation to the lower part for decoupling the upper part from the lower part, wherein the upper engagement portion is configured for transitioning from a disengaged state to an engaged state based on the applying of the at least one engaging action for the engaging, wherein the upper engagement portion is configured for transitioning from the engaged state to the disengaged state based on the applying of the at least one disengaging action for the disengaging.

2. The apparatus of claim 1, wherein the base coupling portion comprises at least one male thread disposed on an outer surface of the base coupling portion, wherein the base comprises a hole comprising at least one female thread disposed on an inner surface of the hole, wherein the at least one male thread is threadedly coupled to the at least one female thread for the coupling of the base coupling portion to the base.

3. The apparatus of claim 1, wherein the object coupling portion comprises an interior space and an opening leading into the interior space, wherein the object coupling portion is configured for receiving at least a portion of the object into the interior space through the opening, wherein the coupling of the object to the object coupling portion is based on the receiving.

4. The apparatus of claim 3, wherein the object coupling portion comprises at least one hole extending from an outer surface of the object coupling portion to an inner surface of the object coupling portion, wherein the inner surface defines the interior space, wherein the at least one hole is engageable with at least one fastening element, wherein the at least one fastening element is transitionable between a fastened position and at least one unfastened position after the engaging of the at least one fastening element with the at least one hole, wherein the at least one fastening element fastens at least the portion of the object to the object coupling portion in the fastened position, wherein the at least one fastening element unfastens at least the portion of the object from the object coupling portion in the at least one unfastened position.

5. The apparatus of claim 1, wherein the object coupling portion comprises an outer surface comprised of a plurality of facets forming at least one polygonal shape.

6. The apparatus of claim 1, wherein the upper engagement portion comprises at least one of at least one first protrusion and at least one first recess arranged in at least one first configuration, wherein the lower engagement portion comprises at least one second recess and at least one second protrusion arranged in at least one second configuration, wherein at least one of the at least one first protrusion and the at least one first recess in the at least one first configuration complements at least one of the at least one second recess and the at least one second protrusion in the at least one second configuration, wherein the at least one first protrusion disengageably engages with the at least one second recess and the at least one second protrusion disengageably engages with the at least one first recess for the disengageably engaging the upper engagement portion with the lower engagement portion.

7. The apparatus of claim 1, wherein the upper part comprises a skirting disposed on an outer surface of the object coupling portion around the object coupling portion, wherein the skirting extends away from the outer surface, wherein the skirting covers at least a portion of the upper engagement portion and the lower engagement portion for protecting at least the portion of the upper engagement portion and the lower engagement portion from at least one external element.

8. The apparatus of claim 1, wherein the lower engagement portion comprises an outer surface comprised of a plurality of facets forming at least one polygonal shape.

9. The apparatus of claim 1, wherein the lower part comprises at least one passage, wherein the at least one passage is configured for receiving at least one tool in the at least one passage, wherein the at least one tool accesses at least one of the upper engagement portion and the lower engagement portion based on the receiving, wherein the at least tool applies at least one external action on at least one of the upper engagement portion and the lower engagement portion for the disengaging the upper engagement portion from the lower engagement portion based on the accessing.

10. The apparatus of claim 1, wherein the upper part comprises a first internal cavity extending from a first end of the upper part to a second end of the upper part, wherein the lower part comprises a second internal cavity extending from a first end of the lower part to a second end of the lower part, wherein the first cavity couples with the second cavity based on the coupling of the upper part with the lower part for forming an internal cavity of the apparatus.

11. An apparatus for frangibly supporting an object to a base, the apparatus comprising:
a lower part comprising a base coupling portion and a lower engagement portion, wherein the base coupling portion is configured to be coupled to the base for attaching the lower part to the base; and
an upper part comprising an object coupling portion and an upper engagement portion, wherein the object coupling portion is configured to be coupled to the object for attaching the object to the upper part, wherein the upper engagement portion is configured to be disengageably engaged with the lower engagement portion for decouplably coupling the upper part with the lower part, wherein a shape of at least a portion of the upper engagement portion complements a shape of at least a portion of the lower engagement portion, wherein the engaging of the upper engagement portion with the lower engagement portion is based on at least one engaging action applied to the upper part in relation to the lower part for the coupling of the upper part with the lower part, wherein the disengaging of the upper engagement portion from the lower engagement portion is based on at least one disengaging action applied to the upper part in relation to the lower part for decoupling the upper part from the lower part, wherein the upper engagement portion is configured for transitioning from a disengaged state to an engaged state based on the applying of the at least one engaging action for the engaging, wherein the upper engagement portion is configured for transitioning from the engaged state to the disengaged state based on the applying of the at least one disengaging action for the disengaging, wherein the upper part comprises a skirting disposed on an outer surface of the object coupling portion around the object coupling portion, wherein the skirting extends away from the outer surface, wherein the skirting covers at least a portion of the upper engagement portion and the lower engagement portion for protecting at least the portion of the upper engagement portion and the lower engagement portion from at least one external element.

12. The apparatus of claim 11, wherein the base coupling portion comprises at least one male thread disposed on an outer surface of the base coupling portion, wherein the base comprises a hole comprising at least one female thread disposed on an inner surface of the hole, wherein the at least one male thread is threadedly coupled to the at least one female thread for the coupling of the base coupling portion to the base.

13. The apparatus of claim 11, wherein the object coupling portion comprises an interior space and an opening leading into the interior space, wherein the object coupling portion is configured for receiving at least a portion of the object into the interior space through the opening, wherein the coupling of the object to the object coupling portion is based on the receiving.

14. The apparatus of claim 13, wherein the upper part comprises at least one hole extending from an outer surface of the upper part to an inner surface of the upper part, wherein the inner surface defines the interior space, wherein the at least one hole is engageable with at least one fastening element, wherein the at least one fastening element is transitionable between a fastened position and at least one unfastened position after the engaging of the at least one fastening element with the at least one hole, wherein the at least one fastening element fastens at least the portion of the object to the object coupling portion in the fastened position, wherein the at least one fastening element unfastens at least the portion of the object from the object coupling portion in the at least one unfastened position.

15. The apparatus of claim 11, wherein the object coupling portion comprises an outer surface comprised of a plurality of facets forming at least one polygonal shape.

16. The apparatus of claim 11, wherein the upper engagement portion comprises at least one of at least one first protrusion and at least one first recess arranged in at least one first configuration, wherein the lower engagement portion comprises at least one second recess and at least one second protrusion arranged in at least one second configuration, wherein at least one of the at least one first protrusion and the at least one first recess in the at least one first configuration complements at least one of the at least one second recess and the at least one second protrusion in the at least one second configuration, wherein the at least one first protrusion disengageably engages with the at least one second recess and the at least one second protrusion disengageably engages with the at least one first recess for the disengageably engaging the upper engagement portion with the lower engagement portion.

17. The apparatus of claim 11, wherein the lower engagement portion comprises an outer surface comprised of a plurality of facets forming at least one polygonal shape.

18. The apparatus of claim 11, wherein the lower part comprises at least one passage, wherein the at least one passage is configured for receiving at least one tool in the at least one passage, wherein the at least one tool accesses at least one of the upper engagement portion and the lower engagement portion based on the receiving, wherein the at least tool applies at least one external action on at least one of the upper engagement portion and the lower engagement portion for the disengaging the upper engagement portion from the lower engagement portion based on the accessing.

19. The apparatus of claim 11, wherein the upper part comprises a first internal cavity extending from a first end of the upper part to a second end of the upper part, wherein the lower part comprises a second internal cavity extending from a first end of the lower part to a second end of the lower part, wherein the first cavity couples with the second cavity based on the coupling of the upper part with the lower part forming an internal cavity of the apparatus.

20. An apparatus for frangibly supporting an object to a base, the apparatus comprising:
a lower part comprising a base coupling portion and a lower engagement portion, wherein the base coupling portion is configured to be coupled to the base for attaching the lower part to the base; and
an upper part comprising an object coupling portion and an upper engagement portion, wherein the object coupling portion is configured to be coupled to the object for attaching the object to the upper part, wherein the upper engagement portion is configured to be disengageably engaged with the lower engagement portion for decouplably coupling the upper part with the lower part, wherein a shape of at least a portion of the upper engagement portion complements a shape of at least a portion of the lower engagement portion, wherein the engaging of the upper engagement portion with the lower engagement portion is based on at least one engaging action applied to the upper part in relation to the lower part for the coupling of the upper part with the lower part, wherein the disengaging of the upper engagement portion from the lower engagement portion is based on at least one disengaging action applied to the upper part in relation to the lower part for decoupling the upper part from the lower part, wherein the upper engagement portion is configured for transitioning from a disengaged state to an engaged state based on the applying of the at least one engaging action for the engaging, wherein the upper engagement portion is configured for transitioning from the engaged state to the disengaged state based on the applying of the at least one disengaging action for the disengaging, wherein the upper engagement portion comprises at least one of at least one first protrusion and at least one first recess arranged in at least one first configuration, wherein the lower engagement portion comprises at least one second recess and at least one second protrusion arranged in at least one second configuration, wherein at least one of the at least one first protrusion and the at least one first recess in the at least one first configuration complements at least one of the at least one second recess and the at least one second protrusion in the at least one second configuration, wherein the at least one first protrusion disengageably engages with the at least one second recess and the at least one second protrusion disengageably engages with the at least one first recess for the disengageably engaging the upper engagement portion with the lower engagement portion, wherein the upper part comprises a skirting disposed on an outer surface of the object coupling portion around the object coupling portion, wherein the skirting extends away from the outer surface, wherein the skirting covers at least a portion of the upper engagement portion and the lower engagement portion for protecting at least the portion of the upper engagement portion and the lower engagement portion from at least one external element.
